(19) United States
(12) Patent Application Publication
(10) Pub. No.: US 2025/0309642 A1
(43) Pub. Date: Oct. 2, 2025

(54) Method and System Based on Improved ADMM for Distributed Coordinated Restoration of Transmission and Distribution Grid

(71) Applicant: Guizhou Power Grid Co., Ltd., Guiyang (CN)

(72) Inventors: Qingsheng LI, Guiyang (CN); Yongqing ZHU, Guiyang (CN); Bin WANG, Guiyang (CN); Zhen LI, Guiyang (CN); Changming CHEN, Guiyang (CN); Zhenzhi LIN, Guiyang (CN); Li YANG, Guiyang (CN); Xuepeng MOU, Guiyang (CN); Zhaofeng ZHANG, Guiyang (CN); Jierui YANG, Guiyang (CN); Zhibang WANG, Guiyang (CN); Tianxuan ZHONG, Guiyang (CN); Dongjunming YANG, Guiyang (CN); Chen LUO, Guiyang (CN); Kuanxiang ZHAO, Guiyang (CN)

(21) Appl. No.: 19/010,800

(22) Filed: Jan. 6, 2025

Related U.S. Application Data
(63) Continuation of application No. PCT/CN2024/138050, filed on Dec. 10, 2024.

(30) Foreign Application Priority Data
Mar. 28, 2024 (CN) 2024103691147

(51) Int. Cl. H02J 3/00

(52) U.S. Cl. CPC H02J 3/00; H02J 2203/20

(57) ABSTRACT

Disclosed are a method and system based on improved alternating direction method of multipliers (ADMM) for distributed coordinated restoration of a transmission and distribution grid. The method includes: establishing an optimization model of maximizing a load restoration yield, and introducing and solving an augmented Lagrangian function; accelerating solutions by using an improved alternating direction method of multipliers and a dual updating iteration accelerating strategy; and determining a coordinated restoration strategy according to convergence conditions or a number of iterations. According to the present disclosure, efficient solving of distributed coordinated restoration of transmission and distribution grid is implemented, economic losses are reduced, and computation complexity and communication burden are further reduced.

### CROSS-REFERENCE TO RELATED APPLICATIONS

The present application claims priority to Chinese Patent Application No. 2024103691147, filed on Mar. 28, 2024, the entire disclosure of which is incorporated herein by reference.

### TECHNICAL FIELD

The present disclosure relates to the technical field of power systems, in particular to a method and system based on improved alternating direction method of multipliers (ADMM) for distributed coordinated restoration of a transmission and distribution grid.

### BACKGROUND

With the rapid development of Energy Internet and smart grids, the coordinated restoration technology of a transmission and distribution grid has attracted increasing attention throughout the industry since it is crucial to improve the toughness and reliability of the grid. A grid system is often at risk of outage and failures once an unpredictable event such as extreme weather and a natural disaster occurs. The outage duration of the grid can be shortened by improving its restoration capacity with the coordinated restoration technology of the transmission and distribution grid. Hence, the grid is guaranteed continuous and stable in power supply. However, data information cannot be shared completely since the transmission and distribution grid operates actually under the jurisdiction of different dispatching entities and further limitation is caused from data information security, privacy protection, etc. As a result, the coordinated restoration technology of the transmission and distribution grid cannot play its full role. Hence, how to balance the distributed coordinated optimization of the transmission and distribution grid and data security and privacy is a hot and thorny issue in the field of smart grid research.

The existing research of the coordinated restoration technology of the transmission and distribution grid still faces numerous challenges and problems despite some headway. For example, the selection and application of a distributed solving algorithm is one of the most prominent problems. The convergence of a traditional alternating direction method of multipliers (ADMM) is extremely sensitive to parameter setting despite that it can implement distributed optimization to some extent. For example, failure of convergence during an algorithm solving process, and even wrong optimization results are likely to occur if parameters are selected improperly. In addition, with the scale expansion and complexity increase of the grid, the coordinated restoration of the transmission and distribution grid develops towards high nonlinearity and complexity, which further escalates the difficulty of distributed solving. As a result, it is a pressing technical problem to improve convergence and stability of the existing distributed algorithm for satisfying the demand for the coordinated restoration of a large-scale complex grid. Besides, the distributed whole-process coordinated restoration of the transmission and distribution grid is also tied to the reduction in computational complexity and communication overhead of the algorithm on the premise of guaranteeing the solving accuracy.

### SUMMARY

An objective of this part is to summarize some aspects of the examples of the present disclosure and briefly introduce some preferred examples. Some simplification or omission can be made in this part, and the abstract of the description and the title of invention of the present disclosure to avoid obscuring objectives of this part, the abstract of the description and the title of invention. Such simplification or omission cannot be used to limit the scope of the present disclosure.

In order to solve the existing problem, the present disclosure is provided. In view of that, the present disclosure provides a method based on improved alternating direction method of multipliers (ADMM) for distributed coordinated restoration of a transmission and distribution grid, which solves the problem of how to increase a convergence speed of distributed solution by improving the alternating direction method of multipliers in a case that information of the transmission and distribution grid is not shared completely, and implement rapid and efficient coordinated restoration of the transmission and distribution grid and reduce economic losses after blackout.

In order to solve the technical problem, the present disclosure provides a technical solution as follows:

In a first aspect, the present disclosure provides a method based on improved alternating direction method of multipliers (ADMM) for distributed coordinated restoration of a transmission and distribution grid. The method includes:
obtaining relevant data of the transmission and distribution grid, establishing an objective function by maximizing a load restoration yield of the transmission and distribution grid, and establishing a coordinated restoration optimization model of the transmission and distribution grid according to the objective function and a constraint condition of the transmission and distribution grid;
establishing augmented objective functions for a transmission grid and a distribution grid by introducing an augmented Lagrangian function based on the coordinated restoration optimization model of the transmission and distribution grid;
setting a maximum number of iterations, an original residual convergence threshold and a dual residual convergence threshold of the improved alternating direction method of multipliers, and solving the augmented objective functions for the transmission grid and the distribution grid by using the improved alternating direction method of multipliers;
updating, by using a dual updating iteration accelerating strategy, a penalty coefficient and a Lagrange multiplier in a case that an original residual is greater than a set threshold, and updating, by using the dual updating iteration accelerating strategy, a Lagrange multiplier and keeping a penalty coefficient unchanged in a case that an original residual is less than or equal to a set threshold; and
determining whether the improved alternating direction method of multipliers continues implementing a next round of optimization or terminates iteration and outputs a final coordinated restoration strategy of the transmission and distribution grid according to convergence conditions of the original residual and a dual residual or a number of iterations.

As a preferred solution of the method based on improved ADMM for distributed coordinated restoration of a transmission and distribution grid of the present disclosure, the establishing a coordinated restoration optimization model of the transmission and distribution grid according to the objective function and a constraint condition of the transmission and distribution grid includes:
expressing the objective function as follows:

$$F = max \text{?} ( \text{?} {b}_{L , n}^{TN} {P}_{L , n , t}^{TN} Δ t + \text{?} {b}_{L , n}^{DN} {P}_{L , n , t}^{DN} Δ t )$$

$$\text{?} \text{indicates text missing or illegible when filed}$$

where N_{bus}^{TN} and N_{bus}^{DN} and denote a number of nodes in the transmission and distribution grid, b_{L,n}^{TN} and b_{L,n}^{DN} denote a load restoration yield per unit of a node n in the transmission grid and a load restoration yield per unit of a node n in the distribution grid respectively, P_{L,n,t}^{TN} and P_{L,n,t}^{DN} denote a load restoration power at a time step t of the node n of the transmission grid and a load restoration power at a time step t of the node n of the distribution grid respectively, Δt denotes a time step interval, and T denotes a number of time steps in a restoration process; and
the constraint condition of the transmission and distribution grid includes a black start constraint, a load restoration constraint and a power balance constraint of a non-black start unit of the transmission grid, as well as a load restoration constraint and a power balance constraint of the distribution grid.

As a preferred solution of the method based on improved ADMM for distributed coordinated restoration of a transmission and distribution grid of the present disclosure, the establishing augmented objective functions for a transmission grid and a distribution grid by introducing an augmented Lagrangian function includes:
expressing the augmented objective function for the transmission grid as follows:

$${f}^{TN} = max {f}^{TN , B} + \text{?} [ {λ}_{DN , x , t}^{TN} ( {P}_{DN , x , t}^{TN} - {P}_{TN , t}^{DN , x} ) ] + \text{?} [ \frac{{ρ}_{DN , x}^{TN}}{2} \text{?} {( \text{?} - \text{?} )}^{2} ]$$

$$\text{?} \text{indicates text missing or illegible when filed}$$

where f^{TN} denotes the augmented objective function for the transmission grid, λD_{N,x,t}^{TN} and ρ_{DN,x}^{TN} denotes a Lagrange multiplier and a penalty factor of the transmission grid respectively, P_{L,n,t}^{TN} denotes the load restoration power of the node n at the time step t of the transmission grid, N_{bus,DN}^{TN} denotes a number of coupling nodes of the transmission and distribution grid, T_{Step} denotes the number of time steps in the restoration process, P_{DN,n,t}^{TN} denotes a transmission and distribution grid interaction power expected, by the transmission grid, to be received by an n^{th} distribution grid, P_{TN,t}^{DN,n} denotes a transmission and distribution grid interaction power at which the n^{th} distribution grid expects the transmission grid to transmit, and f^{TN,B} denotes a restoration yield of the transmission grid; and
expressing the augmented objective function for the distribution grid as follows:

$${f}^{DN , n} = max {f}^{DN , n , B} + \text{?} [ {λ}_{TN , t}^{DN , n} ( {P}_{DN , n , t}^{TN} - {P}_{TN , t}^{DN , n} ) ] + \frac{{ρ}_{TN}^{DN , n}}{2} \text{?} {( {P}_{DN , n , t}^{TN} - {P}_{TN , t}^{DN , n} )}^{2}$$

$$\text{?} \text{indicates text missing or illegible when filed}$$

where f^{DN,n} denotes the augmented objective function for the distribution grid, Δ_{TN,t}^{DN} and ρ_{TN}^{DN,n} denotes a Lagrange multiplier and a penalty factor of the n^{th} distribution grid respectively, P_{L,n,t}^{DN} denotes the load restoration power of the node n at the time step t of the distribution grid, T_{Step} denotes the number of time steps in the restoration process, P_{DN,n,t}^{TN} denotes the transmission and distribution grid interaction power expected, by the transmission grid, to be received by the n^{th} distribution grid, P_{TN,t}^{DN,n} denotes the transmission and distribution grid interaction power at which the n^{th} distribution grid expects the transmission grid to transmit, and denotes a restoration yield of the distribution grid.

As a preferred solution of the method based on improved ADMM for distributed coordinated restoration of a transmission and distribution grid of the present disclosure, the solving the augmented objective functions for the transmission grid and the distribution grid by using the improved alternating direction method of multipliers includes:
downwards collecting expected transmission and distribution interaction power strategy matrices of distribution grids by the transmission grid, computing the augmented objective function for the transmission grid, and obtaining an expected transmission and distribution interaction power strategy matrix of the transmission grid; and
receiving the expected transmission and distribution interaction power strategy matrix of the transmission grid from the transmission grid by each distribution grid, then computing the augmented objective function for the distribution grid, and obtaining the expected transmission and distribution interaction power strategy matrix of the distribution grid.

As a preferred solution of the method based on improved ADMM for distributed coordinated restoration of a transmission and distribution grid of the present disclosure, the updating, by using a dual updating iteration accelerating strategy, a penalty coefficient and a Lagrange multiplier in a case that an original residual is greater than a set threshold includes:
updating the penalty coefficient as follows:

$${ρ}_{DN , n}^{TN , k + 1} = \{ \begin{matrix}{ρ}_{DN , n}^{TN , k} / [ 1 + lg ( \frac{{d}_{DN , n}^{TN , k , D}}{{p}_{DN , n}^{TN , k , P}} ) ] , ( \frac{{d}_{DN , n}^{TN , k , D}}{{δ}^{D}} ) \geq \frac{10 {p}_{DN , n}^{TN , k , P}}{{δ}^{P}} \\ {ρ}_{DN , n}^{TN , k} [ 1 + lg ( \frac{{p}_{DN , n}^{TN , k , D}}{{d}_{DN , n}^{TN , k , P}} ) ] , ( \frac{{p}_{DN , n}^{TN , k , P}}{{δ}^{P}} ) \geq \frac{10 {p}_{DN , n}^{TN , k , D}}{{δ}^{D}} \\ {ρ}_{DN , n}^{TN , k} , Others\end{matrix}$$

$${ρ}_{TN}^{DN , n , k + 1} = \{ \begin{matrix}{ρ}_{TN}^{DN , n , k} / [ 1 + lg ( \frac{{d}_{TN}^{DN , n , k , D}}{{p}_{TN}^{DN , n , k , P}} ) ] , ( \frac{{d}_{TN}^{DN , n , k , D}}{{δ}^{D}} ) \geq \frac{10 {p}_{TN}^{DN , n , k , P}}{{δ}^{P}} \\ {ρ}_{TN , n}^{DN , k} [ 1 + lg ( \frac{{p}_{TN}^{DN , n , k , P}}{{d}_{TN}^{DN , n , k , D}} ) ] , ( \frac{{p}_{TN}^{DN , n , k , P}}{{δ}^{P}} ) \geq \frac{10 {p}_{TN}^{DN , n , k , D}}{{δ}^{D}} \\ {ρ}_{TN}^{DN , n , k} , Others\end{matrix}$$

where P_{DN,n}^{TN,k,p}=P_{TN}^{DN,n,k,p} denotes an original residual of a k^{th} iteration of the transmission and distribution grid, d_{DN,n}^{TN,k,D}=d_{TN}^{DN,n,k,D} denotes a dual residual of the k^{th} iteration of the transmission and distribution grid, ρ_{DN,n}^{TN,k+1} denotes a penalty coefficient of a k+1^{th} iteration of the transmission grid, ρ_{DN,n}^{TN,k} denotes a penalty coefficient of a k^{th} iteration of the transmission grid, ρ_{TN}^{DN,n,k+1} denotes a penalty coefficient of a k+1^{th} iteration of a node of the n^{th} distribution grid, ρ_{TN}^{DN,n,k} denotes a penalty coefficient of a k^{th} iteration of the node of the n^{th} distribution grid, δ^{P} denotes the original residual convergence threshold and δ^{D} denotes the dual residual convergence threshold; and
updating the Lagrange multiplier as follows:

$${λ}_{DN , n , t}^{TN , k + 1} = {λ}_{DN , n , t}^{TN , k} + {ρ}_{DN , n}^{TN , k + 1} ( {P}_{DN , n , t}^{TN , k + 1} - {P}_{TN , t}^{DN , n , k + 1} )$$

$${λ}_{TN , t}^{DN , n , k + 1} = {λ}_{TN , t}^{DN , n , k} + {ρ}_{TN , t}^{DN , n , k + 1} ( {P}_{DN , n , t}^{TN , k + 1} - {P}_{TN , t}^{DN , n , k + 1} )$$

where P_{DN,n,t}^{TN,k+1} denotes an expected transmission and distribution interaction power strategy matrix at a time step t in the k+1^{th} iteration of the transmission grid, P_{TN,t}^{DN,n,k+1} denotes a transmission and distribution interaction power strategy matrix at a time step t in a k+1^{th} iteration of the distribution grid, λ_{DN,n,t}^{TN,k+1} denotes a Lagrange multiplier at the time step t in the k+1^{th} iteration of the transmission grid, λ_{DN,n,t}^{TN,k} denotes a Lagrange multiplier at a time step t in the k^{th} iteration of the transmission grid, λ_{TN,t}^{DN,n,k+1} denotes a Lagrange multiplier at a time step t in the k+1^{th} iteration of the node of the n^{th} distribution grid, λ_{TN,t}^{DN,n,k} denotes a Lagrange multiplier at a time step t in the k^{th} iteration of the node of the nth distribution grid, ρ_{DN,n}^{TN,k+1} denotes the penalty coefficient of the k+1^{th} iteration of the transmission grid and ρ_{TN,t}^{DN,n,k+1} denotes a penalty coefficient of the k+1^{th} iteration of the distribution grid.

As a preferred solution of the method based on improved ADMM for distributed coordinated restoration of a transmission and distribution grid of the present disclosure, the updating, by using the dual updating iteration accelerating strategy, a Lagrange multiplier and keeping a penalty coefficient unchanged in a case that an original residual is less than or equal to a set threshold includes:
updating the Lagrange multiplier as follows:

$${λ}_{DN , n , t}^{TN , k + 1} = {λ}_{DN , n , t}^{TN , k} + {ρ}_{DN , n}^{TN , k + 1} ( {P}_{DN , n , t}^{TN , k + 1} - {P}_{TN , t}^{DN , n , k + 1} ) + {K}^{D} [ ( {P}_{DN , n , t}^{TN , k + 1} - {P}_{TN , t}^{DN , n , k + 1} ) - ( {P}_{DN , n , t}^{TN , k} - {P}_{TN , t}^{DN , n , k} ) ] + {K}^{I} \text{?} ( {P}_{DN , n , t}^{TN , m + 1} - {P}_{TN , t}^{DN , n , m + 1} )$$

$${λ}_{TN , t}^{DN , n , k + 1} = {λ}_{TN , t}^{DN , n , k} + {ρ}_{TN , t}^{DN , n , k + 1} ( {P}_{DN , n , t}^{TN , k + 1} - {P}_{TN , t}^{DN , n , k + 1} ) + {K}^{D} [ ( {P}_{DN , n , t}^{TN , k + 1} - {P}_{TN , t}^{DN , n , k + 1} ) - ( {P}_{DN , n , t}^{TN , k} - {P}_{TN , t}^{DN , n , k} ) ] + {K}^{I} \text{?} ( {P}_{DN , n , t}^{TN , m + 1} - {P}_{TN , t}^{DN , n , m + 1} )$$

$$\text{?} \text{indicates text missing or illegible when filed}$$

where λ_{DN,n,t}^{TN,k+1} denotes the Lagrange multiplier at the time step t in the k+1^{th} iteration of the transmission grid, λ_{DN,n,t}^{TN,k} denotes the Lagrange multiplier at the time step t in the k^{th} iteration of the power grid, λ_{TN,t}^{DN,n,k+1} denotes the Lagrange multiplier at the time step t in the k+1^{th} iteration of the node of the n^{th} distribution grid, λ_{TN,t}^{DN,n,k} denotes the Lagrange multiplier at the time step t in the k^{th} iteration of the node of the n^{th} distribution grid, ρ_{DN,n}^{TN,k+1} denotes the penalty coefficient of the k+1^{th} iteration of the transmission grid, ρ_{TN,t}^{DN,n,k+1} denotes the penalty coefficient of the k+1 iteration of the distribution grid, K^{D} and K¹ denote an integral and a dual residual adjustment parameter in a classical control theory respectively, P_{DN,n,t}^{TN,k+1} denotes an expected transmission and distribution interaction power strategy matrix at the t step in the k+1^{th} iteration of the transmission grid and P_{TN,t}^{DN,n,k+1} denotes a transmission and distribution interaction power strategy matrix at a time step t in the k+1^{th} iteration of the distribution grid.

As a preferred solution of the method based on improved ADMM for distributed coordinated restoration of a transmission and distribution grid of the present disclosure, the determining whether the improved alternating direction method of multipliers continues implementing a next round of optimization or terminates iteration and outputs a final coordinated restoration strategy of the transmission and distribution grid according to convergence conditions of the original residual and a dual residual or a number of iterations includes:
determining the convergence conditions of the original residual and the dual residual in expressions as follows:

$${p}_{DN , n}^{TN , k , P} \leq {δ}^{P} ⋂ {d}_{DN , n}^{TN , k , d} \leq {δ}^{D} = 1$$

where P_{DN,n}^{TN,k,p}=P_{TN}^{DN,n,k,p} denotes the original residual of the k^{th} iteration of the transmission and distribution grid, d_{DN,n}^{TN,k,d}=d_{TN}^{DN,n,k,D} denotes the dual residual of the k^{th} iteration of the transmission and distribution grid, δ^{P} denotes the original residual convergence threshold and δ^{D} denotes the dual residual convergence threshold; and
in a case that the improved alternating direction method of multipliers satisfies the expressions of the convergence conditions of the original residual and the dual residual, or reaches the maximum number of iterations, outputting the final coordinated restoration strategy of the transmission and distribution grid.

In a second aspect, the present disclosure provides a system based on improved ADMM for distributed coordinated restoration of a transmission and distribution grid. The system includes:
a data obtainment module configured to obtain relevant data of the transmission and distribution grid, and establish an objective function by maximizing a load restoration yield of the transmission and distribution grid;
an optimization model establishment module configured to establish a coordinated restoration optimization model of the transmission and distribution grid according to the objective function and a constraint condition of the transmission and distribution grid;
a distributed restoration optimization module configured to establish augmented objective functions for a transmission grid and a distribution grid by introducing an augmented Lagrangian function based on the coordinated restoration optimization model of the transmission and distribution grid;
an iteration solving module configured to set a maximum number of iterations, an original residual convergence threshold and a dual residual convergence threshold of the improved alternating direction method of multipliers, and solve the augmented objective functions for the transmission grid and the distribution grid by using the improved alternating direction method of multipliers;
an iteration accelerating strategy module configured to update, by using a dual updating iteration accelerating strategy, a penalty coefficient and a Lagrange multiplier in a case that an original residual is greater than a set threshold, and update, by using the dual updating iteration accelerating strategy, a Lagrange multiplier and keeping a penalty coefficient unchanged in a case that an original residual is less than or equal to a set threshold; and
an optimization result output module configured to determine whether the improved alternating direction method of multipliers continues implementing a next round of optimization or terminates iteration and outputs a final coordinated restoration strategy of the transmission and distribution grid according to convergence conditions of the original residual and a dual residual or a number of iterations.

In a third aspect, the present disclosure provides a computation device. The computation device includes:
a memory and a processor; where
the memory is configured to store a computer-executable instruction, the processor is configured to execute the computer-executable instruction, and the computer-executable instruction implements steps of the method based on improved ADMM for distributed coordinated restoration of a transmission and distribution grid when executed by the processor.

In a fourth aspect, the present disclosure provides a computer-readable storage medium. The computer-readable storage medium stores a computer-executable instruction, where the computer-executable instruction implements steps of the method based on improved ADMM for distributed coordinated restoration of a transmission and distribution grid when executed by a processor.

Compared with the prior art, the method has the beneficial effects: with the improved alternating direction method of multipliers of the present disclosure, the distributed coordinated restoration of the transmission and distribution grid is solved efficiently, the restoration speed is improved and the economic losses are reduced. A solving process is optimized by adaptively adjusting the penalty factor, computation complexity and communication burden are reduced, practicability of the model is obviously enhanced, and strong technical support is provided for stable operation of a power system and social and economic development.

### BRIEF DESCRIPTION OF DRAWINGS

To describe technical solutions of examples of the present disclosure more clearly, accompanying drawings required for description of the examples are briefly described below. Apparently, the accompanying drawings in the following description show merely some examples of the present disclosure, and a person of ordinary skill in the art can still derive other accompanying drawings from these accompanying drawings without creative efforts. In the figures:

FIG. 1 is a schematic overall flowchart of a method based on improved alternating direction method of multipliers (ADMM) for distributed coordinated restoration of a transmission and distribution grid according to an example of the present disclosure;

FIG. 2 is a schematic topological diagram of a 179-node power system of a method based on improved ADMM for distributed coordinated restoration of a transmission and distribution grid according to an example of the present disclosure;

FIG. 3 is a schematic diagram of power balance of a transmission grid in three disaster scenarios of a method based on improved ADMM for distributed coordinated restoration of a transmission and distribution grid according to an example of the present disclosure; and

FIG. 4 is a schematic diagram of restoration of electricity generation power and load power of a transmission system in three scenarios of a method based on improved ADMM for distributed coordinated restoration of a transmission and distribution grid according to an example of the present disclosure;

### DETAILED DESCRIPTION OF THE EMBODIMENTS

To make the above objectives, features and advantages of the present disclosure clearer and more comprehensible, specific embodiments of the present disclosure will be described below in detail with reference to accompanying drawings of the description. Apparently, the examples described are some examples rather than all examples of the present disclosure. All other examples derived by those skilled in the art from the examples of the present disclosure without creative efforts should fall within the protection scope of the present disclosure.

Many specific details are set forth in the following description to facilitate full understanding of the present disclosure, but the present disclosure can further be implemented in other ways different from those described herein. Similar extension can be made by those skilled in the art without departing from the contents of the present disclosure, and the present disclosure is not limited by the specific examples disclosed below accordingly.

Secondly, “one example”, “an example” or “the example” referred to herein indicates a specific feature, structure or characteristic that can be included in at least one implementation of the present disclosure. The “in an example” or “in one example” throughout this description does not indicate the same example, nor a separate or selective example mutually exclusive of other examples.
the present disclosure will be described in detail with reference to the schematic diagram. When describing the example of the present disclosure in detail, a sectional view showing a device structure will not be partially enlarged in general proportion for the convenience of description, and the schematic diagram is merely illustrative, and should not limit the protection scope of the present disclosure herein. In addition, a three-dimensional dimensions of length, width and depth should be included in actual production.

In the description of the present disclosure, it should be noted that the orientation or positional relations indicated by the terms “up”, “down”, “inside”, “outside”, etc. are based on the orientation or positional relation shown in the accompanying drawings and are merely for facilitating the description of the present disclosure and simplifying the description, rather than indicating or implying that a system or element referred to must have a particular orientation or be constructed and operated in a particular orientation, and thus cannot be interpreted as limitation to the present disclosure. In addition, the terms “first”, “second”, “third”, etc. are merely used for description and cannot be understood as indicating or implying relative importance.

In the present disclosure, unless otherwise explicitly specified and defined, the terms such as “mount”, “connecting” and “connection” should be understood in a broad sense. For example, a connection can be a fixed connection, a detachable connection or an integrated connection, can be a mechanical connection or an electric connection, can be a direct connection or an indirect connection through an intermediate medium, and can be internal communication of two elements. For those of ordinary skill in the art, specific meanings of the above terms in the present disclosure can understood according to specific circumstances.

### Example 1

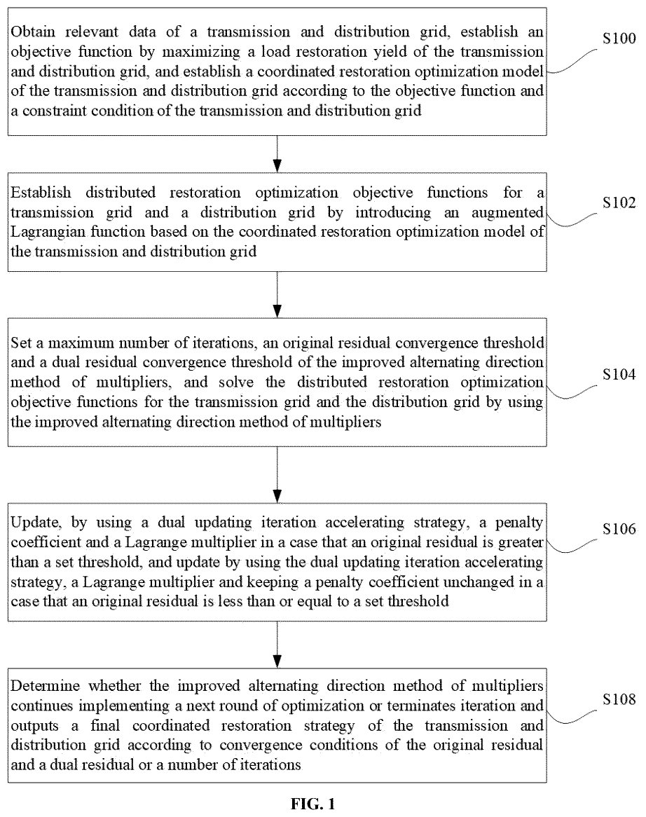

With reference to FIG. 1, a method based on improved alternating direction method of multipliers (ADMM) for distributed coordinated restoration of a transmission and distribution grid is provided according to an example of the present disclosure. The method includes:

S100: relevant data of the transmission and distribution grid are obtained, an objective function is established by maximizing a load restoration yield of the transmission and distribution grid, and a coordinated restoration optimization model of the transmission and distribution grid is established according to the objective function and a constraint condition of the transmission and distribution grid.

Further, the objective function is expressed as follows:

$$F = max {\sum }_{t = 1}^{T} ( \text{?} {b}_{L , n}^{TN} {P}_{L , n , t}^{TN} Δ t + \text{?} {b}_{L , n}^{DN} {P}_{L , n , t}^{DN} Δ t )$$

$$\text{?} \text{indicates text missing or illegible when filed}$$

In the formula, N_{bus}^{TN} and N_{bus}^{DN} denote a number of nodes in the transmission and distribution grid, b_{L,n}^{TN} and b_{L,n}^{DN} denote a load restoration yield per unit of a node n in the transmission grid and a load restoration yield per unit of a node n in the distribution grid respectively, P_{L,n,t}^{TN} and P_{L,n,t}^{DN} denote a load restoration power at a time step t of the node n of the transmission grid and a load restoration power at a time step t of the node n of the distribution grid respectively, Δt denotes a time step interval, and T denotes a number of time steps in a restoration process.

The constraint condition of the transmission and distribution grid includes a black start constraint, a load restoration constraint and a power balance constraint of a non-black start unit of the transmission grid, as well as a load restoration constraint and a power balance constraint of the distribution grid.

Preferably, the transmission grid generally includes large thermal power units. Such units are difficult to implement black start after blackout, and are referred to as non-black start units. A black start constraint of these non-black start units is expressed as follows:

$${P}_{NBS , n , t}^{TN} = \{ \begin{matrix}0 , & t < {t}_{1} \\ ( t - {t}_{1} ) {R}_{NBS , n}^{TN} - {P}_{NBS , n}^{TN , st} & {t}_{1} \leq t < {t}_{2} \\ {P}_{NBS , n}^{TN , max} - {P}_{NBS , n}^{TN , st} , & t \geq {t}_{2}\end{matrix}$$

$${\sum }_{t = 1}^{T} ( 1 - {B}_{bus , n , t}^{TN} ) \leq {T}_{NBS , n}^{TN , st}$$

$${T}_{NBS , n}^{TN , st , min} \leq {T}_{NBS , n}^{TN , st} \leq {T}_{NBS , n}^{TN , st , max}$$

In the formula, P_{NBS,n,t}^{TN}, P_{NBS,n}^{TN,st} and P_{NBS,n}^{TN,max} denote a restoration electricity generation power, an auxiliary electric power and a rated power of a neutral bus switch (NBS) at the time step t of the n node of the transmission grid respectively, R_{NBS,n}^{TN} denotes a climbing power of the NBS, t₁ and t₂ denote an initial time step of NBS restoration and a time step of restoration to the rated power, B_{bus,n,t}^{TN} denotes a Boolean variable of a restoration state of a node where the NBS is located, and T_{NBS,n}^{TN,st,max} and T_{NBS,n}^{TN,st,min} denote an upper limit and a lower limit of black start time of the non-black start unit respectively.

Preferably, a load constraint condition of the transmission grid is expressed as follows:

$$0 \leq {P}_{n , t - 1}^{DN , L} \leq {P}_{n , t}^{DN , L} \leq {P}_{n}^{DN , L , max} , ∀ n ∈ {Ω}_{bus}^{DN , NFL}$$

$$0 \leq {P}_{n , t}^{DN , L} \leq {P}_{n}^{DN , L , max} , ∀ n ∈ {Ω}_{bus}^{DN , FL}$$

$${P}_{n , t}^{DN , L} - {P}_{n , t - 1}^{DN , L} \leq Δ {P}_{n , t}^{DN , L , max}$$

$${B}_{bus , n , t}^{DN , L} \leq {B}_{bus , n , t - 1}^{DN}$$

In the formula, P_{n,t}^{DN,L} and Pₙ^{DN,L,max} denote a restored load power and a load rated power of the node n of the transmission grid respectively, Ω_{bus}^{DN,NFL} and Ω_{bus}^{DN,FL} n denote a node set of loads incapable of participating in demand response and a node set of loads capable of participating in demand response in the transmission grid, ΔP_{n,t}^{DN,L,max} denotes a restorable load upper limit at each time step, B_{bus,n,t}^{DN,L} denotes a load restoration state variable of the node n of the transmission grid, and B_{bus,n,t}^{DN,L} and B_{bus,n,t-1}^{DN} denote load restoration state variables of the node n of the transmission grid node N at time t and time t−1 respectively.

It should be noted that a load constraint of the distribution grid is expressed in the same way as the load constraint condition of the transmission grid.

Preferably, power balance constraints of the transmission grid and the distribution grid are expressed as follows:

$$\text{?} ( {P}_{NBS , n , t}^{TN} + {P}_{BS , n , t}^{TN} + {P}_{RES , n , t}^{TN} + {P}_{ES , n , t}^{TN} ) = \text{?} ( {P}_{L , n , t}^{TN} + {P}_{DN , n , t}^{TN} )$$

$${P}_{DN , n , t}^{TN} + \text{?} ( {P}_{RES , x , t}^{DN , n} + {P}_{ES , x , t}^{DN , n} ) = \text{?} {P}_{L , x , t}^{DN , n}$$

$$\text{?} \text{indicates text missing or illegible when filed}$$

In the formula, Ω_{bus}^{TN} and Ω_{bus}^{DN,n} denote a node set of the transmission grid and a distribution grid connected to the node n of the transmission grid respectively, P_{BS,n,t}^{TN}, P_{RES,n,t}^{TN} and P_{ES,n,t}^{TN} denote electricity generation powers of a black start unit, a new energy unit and an energy storage device of the node n of the transmission grid respectively, P_{L,n,t}^{TN} denotes a load power of the node n of the transmission grid, P_{DN,n,t}^{TN} denotes a transmission and distribution grid interaction power provided by the transmission grid for the distribution grid connected to the node n of the transmission grid, and P_{RES,x,t}^{DN,n}, P_{ES,x,t}^{DN,n} and P_{L,x,t}^{DN,n} denote output of a new energy unit, output of an energy storage device and a load demand power of a node x of a transmission grid connected to the node n of the transmission grid respectively.

It should be noted that by establishing the coordinated restoration optimization model with the goal of maximizing the load restoration yield of the transmission and distribution grid and considering various constraint conditions, optimal allocation of resources and rapid and efficient restoration of the grid are implemented, and decision-making efficiency and an intelligence level of the grid are improved. Thus, solid guarantee is provided for safe and stable operation of the grid.

S102: augmented objective functions for a transmission grid and a distribution grid are established by introducing an augmented Lagrangian function based on the coordinated restoration optimization model of the transmission and distribution grid.

Further, the augmented objective function for the transmission grid is expressed as follows:

$${f}^{TN} = max {f}^{TN , B} + {\sum }_{x = 1}^{{N}_{bus , DN}^{TN}} {\sum }_{t = 1}^{{T}_{step}} [ {λ}_{DN , x , t}^{TN} ( {P}_{DN , x , t}^{TN} - {P}_{TN , t}^{DN , x} ) ] + {\sum }_{x = 1}^{{N}_{bus , DN}^{TN}} [ \frac{{ρ}_{DN , x}^{TN}}{2} {\sum }_{i = 1}^{{T}_{step}} {( {P}_{DN , x , t}^{TN} - {P}_{TN , t}^{DN , x} )}^{2} ]$$

In the formula, f^{TN} denotes the augmented objective function for the transmission grid, λ_{DN,x,t}^{TN} and ρ_{DN,x}^{TN} denotes a Lagrange multiplier and a penalty factor of the transmission grid respectively, P_{L,n,t}^{TN} denotes the load restoration power of the node n at the time step t of the transmission grid, N_{bus,DN}^{TN} denotes a number of coupling nodes of the transmission and distribution grid, T_{Step} denotes the number of time steps in the restoration process, P_{DN,n,t}^{TN} denotes a transmission and distribution grid interaction power expected, by the transmission grid, to be received by an n^{th} distribution grid, P_{TN,t}^{DN,n} denotes a transmission and distribution grid interaction power at which the n^{th} distribution grid expects the transmission grid to transmit, and f^{TN,B} denotes a restoration yield of the transmission grid.

The augmented objective function for the distribution grid is expressed as follows:

$${f}^{DN , n} = max {f}^{DN , n , B} + {\sum }_{i = 1}^{{T}_{step}} [ {λ}_{TN , t}^{DN , n} ( {P}_{DN , n , t}^{TN} - {P}_{TN , t}^{DN , n} ) ] + \frac{{ρ}_{TN}^{DN , n}}{2} {\sum }_{i = 1}^{{T}_{step}} {( {P}_{DN , n , t}^{TN} - {P}_{TN , t}^{DN , n} )}^{2}$$

In the formula, f^{DN,n} denotes the augmented objective function for the distribution grid, λ_{TN,t}^{DN,n} and ρ_{TN}^{DN,n} denotes a Lagrange multiplier and a penalty factor of the n^{th} distribution grid respectively, P_{L,n,t}^{DN} denotes the load restoration power of the node n at the time step t of the distribution grid, T_{Step} denotes the number of time steps in the restoration process, P_{DN,n,t}^{TN} denotes the transmission and distribution grid interaction power expected, by the transmission grid, to be received by the n^{th} distribution grid, P_{TN,t}^{DN,n} denotes the transmission and distribution grid interaction power at which the n^{th} distribution grid expects the transmission grid to transmit, and f^{DN,n,B} denotes a restoration yield of the distribution grid.

Preferably, restoration yields of the transmission grid and the distribution grid are expressed as follows:

$${f}^{TN , B} = {\sum }_{t = 1}^{T} {\sum }_{n = 1}^{{N}_{bus}^{TN}} {b}_{L , n}^{TN} {P}_{L , n , t}^{TN} Δ t$$

$${f}^{DN , n , B} = {\sum }_{t = 1}^{T} {\sum }_{n = 1}^{{N}_{bus}^{DN}} {b}_{L , n}^{DN} {P}_{L , n , t}^{DN} Δ t$$

In the formula, f^{TN,B} denotes the restoration yield of the transmission grid, f^{DN,n,B} denote the restoration yield of the distribution grid, b_{L,n}^{TN} and b_{L,n}^{DN} denote a load restoration yield per unit of the node n in the transmission grid and a load restoration yield per unit of the node n in the distribution grid respectively, Δt denotes a time step interval, T denotes a number of time steps in a restoration process, and P_{L,n,t}^{TN} and P_{L,n,t}^{DN} denote a load restoration power at a time step t of the node n of the transmission grid and a load restoration power at a time step t of the node n of the distribution grid respectively.

It should be noted that according to this technical solution, the augmented objective functions for the transmission grid and the distribution grid are established by introducing the augmented Lagrangian function, and distributed optimization of the coordinated restoration of the transmission and distribution grid is implemented. Besides consideration of the load restoration yield of the transmission and distribution grid, power balance and satisfaction of the constraint condition are guaranteed in the restoration process of the transmission and distribution grid by introducing the Lagrange multiplier and the penalty factor. Through the distributed optimization, computational complexity is reduced, optimization efficiency is improved, and overall optimization of the restoration strategy is guaranteed.

S104: a maximum number of iterations, an original residual convergence threshold and a dual residual convergence threshold of the improved alternating direction method of multipliers are set, and the augmented objective functions for the transmission grid and the distribution grid are solved by using the improved alternating direction method of multipliers.

Further, expected transmission and distribution interaction power strategy matrices of distribution grids are downwards collected by the transmission grid, the augmented objective function for the transmission grid is computed, and an expected transmission and distribution interaction power strategy matrix of the transmission grid is obtained.

The expected transmission and distribution interaction power strategy matrix of the transmission grid is received from the transmission grid by each distribution grid, then the augmented objective function for the distribution grid is computed, and the expected transmission and distribution interaction power strategy matrix of the distribution grid is obtained.

It should be noted that the node of the current n^{th} distribution grid receives the expected interaction power strategy of the transmission grid, and computes its own restoration strategy based on this information. After computation is completed, n is increased by 1, proceeding to a node of a next distribution grid is implemented for being processed, and the operation is repeated until all nodes of the distribution grid (that is, n reaches a total number of the nodes of the distribution grid) are processed.

It should be further noted that the distributed solution method reduces the computation complexity and computation amount, and improves the optimization efficiency. Through improvement of the alternating direction method of multipliers, convergence and stability of the algorithm are enhanced, and solving results are more accurate and reliable. By setting a reasonable convergence threshold, it is ensured that an optimal solution can be quickly obtained through convergence in the solving process while an accuracy requirement is satisfied.

S106: a penalty coefficient and a Lagrange multiplier are updated by using a dual updating iteration accelerating strategy in a case that an original residual is greater than a set threshold, and a Lagrange multiplier is updated by using the dual updating iteration accelerating strategy and a penalty coefficient is kept unchanged in a case that an original residual is less than or equal to a set threshold.

Further, the penalty coefficient and the Lagrange multiplier are updated in a case that the original residual is greater than the set threshold. The penalty coefficient is updated as follows:

$${ρ}_{DN , n}^{TN , k + 1} = \{ \begin{matrix}{ρ}_{DN , n}^{TN , k} / [ 1 + lg ( \frac{{d}_{DN , n}^{TN , k , D}}{{p}_{DN , n}^{TN , k , P}} ) ] , & ( \frac{{d}_{DN , n}^{TN , k , D}}{{δ}^{D}} ) \geq \frac{10 {p}_{DN , n}^{TN , k , P}}{{δ}^{P}} \\ {ρ}_{DN , n}^{TN , k} [ 1 + lg ( \frac{{p}_{DN , n}^{TN , k , P}}{{d}_{DN , n}^{TN , k , D}} ) ] , & ( \frac{{p}_{DN , n}^{TN , k , P}}{{δ}^{P}} ) \geq \frac{10 {d}_{DN , n}^{TN , k , D}}{{δ}^{D}} \\ {ρ}_{DN , n}^{TN , k} , & Others\end{matrix}$$

$${ρ}_{TN}^{DN , n , k + 1} = \{ \begin{matrix}{ρ}_{TN}^{DN , n , k} / [ 1 + lg ( \frac{{d}_{TN}^{DN , n , k , D}}{{p}_{TN}^{DN , n , k , P}} ) ] , & ( \frac{{d}_{TN}^{DN , n , k , D}}{{δ}^{D}} ) \geq \frac{10 {p}_{TN}^{DN , n , k , P}}{{δ}^{P}} \\ {ρ}_{TN}^{DN , n , k} [ 1 + lg ( \frac{{p}_{TN}^{DN , n , k , P}}{{d}_{TN}^{DN , n , k , D}} ) ] , & ( \frac{{p}_{TN}^{DN , n , k , P}}{{δ}^{P}} ) \geq \frac{10 {d}_{TN}^{DN , n , k , D}}{{δ}^{D}} \\ {ρ}_{TN}^{DN , n , k} , & Others\end{matrix}$$

In the formula, P_{DN,n}^{TN,k,p}=P_{TN}^{DN,n,k,p} denotes an original residual of a k^{th} iteration of the transmission and distribution grid, d_{DN,n}^{TN,k,D}=d_{TN}^{DN,n,k,D} denotes a dual residual of the k^{th} iteration of the transmission and distribution grid, ρ_{DN,n}^{TN,k+1} denotes a penalty coefficient of a k+1^{th} iteration of the transmission grid, ρ_{DN,n}^{TN,k} denotes a penalty coefficient of a k^{th} iteration of the transmission grid, ρ_{TN}^{DN,n,k+1} denotes a penalty coefficient of a k+1^{th} iteration of a node of the n^{th} distribution grid, ρ_{TN}^{DN,n,k} denotes a penalty coefficient of a k^{th} iteration of the node of the n^{th} distribution grid, δ^{P} denotes the original residual convergence threshold and δ^{D} denotes the dual residual convergence threshold.

The Lagrange multiplier is updated as follows:

$${λ}_{DN , n , t}^{TN , k + 1} = {λ}_{DN , n , t}^{TN , k} + {ρ}_{DN , n}^{TN , k + 1} ( {P}_{DN , n , t}^{TN , k + 1} - {P}_{TN , t}^{DN , n , k + 1} )$$

$${λ}_{TN , t}^{DN , n , k + 1} = {λ}_{TN , t}^{DN , n , k} + {ρ}_{TN , t}^{DN , n , k + 1} ( {P}_{DN , n , t}^{TN , k + 1} - {P}_{TN , t}^{DN , n , k + 1} )$$

In the formula, P_{DN,n,t}^{TN,k+1} denotes an expected transmission and distribution interaction power strategy matrix at a time step t in the k+1^{th} iteration of the transmission grid, P_{TN,t}^{DN,n,k+1} denotes a transmission and distribution interaction power strategy matrix at a time step t in a k+1^{th} iteration of the distribution grid, λ_{DN,n,t}^{TN,k+1} denotes a Lagrange multiplier at the time step t in the k+1^{th} iteration of the transmission grid, λ_{DN,n,t}^{TN,k} denotes a Lagrange multiplier at a time step t in the k^{th} iteration of the transmission grid, λ_{TN,t}^{DN,n,k+1} denotes a Lagrange multiplier at a time step t in the k+1^{th} iteration of the node of the n^{th} distribution grid, λ_{TN,t}^{DN,n,k} denotes a Lagrange multiplier at a time step t in the k^{th} iteration of the node of the nth distribution grid, ρ_{DN,n}^{TN,k+1} denotes the penalty coefficient of the k+1th iteration of the transmission grid and ρ_{TN,t}^{DN,n,k+1} denotes a penalty coefficient of the k+1^{th} iteration of the distribution grid.

Further, the Lagrange multiplier is updated and the penalty coefficient is kept unchanged in a case that the original residual is less than or equal to the set threshold. The Lagrange multiplier is updated as follows:

$${λ}_{DN , n , t}^{TN , k + 1} = {λ}_{DN , n , t}^{TN , k} + {ρ}_{DN , n}^{TN , k + 1} ( {P}_{DN , n , t}^{TN , k + 1} - {P}_{TN , t}^{DN , n , k + 1} ) + {K}^{D} [ ( {P}_{DN , n , t}^{TN , k + 1} - {P}_{TN , t}^{DN , n , k + 1} ) - ( {P}_{DN , n , t}^{TN , k} - {P}_{TN , t}^{DN , n , k} ) ] + {K}^{I} {\sum }_{m = {k}^{*}}^{k} ( {P}_{DN , n , t}^{TN , m + 1} - {P}_{TN , t}^{DN , n , m + 1} )$$

$${λ}_{TN , t}^{DN , n , k + 1} = {λ}_{TN , t}^{DN , n , k} + {ρ}_{TN , t}^{DN , n , k + 1} ( {P}_{DN , n , t}^{TN , k + 1} - {P}_{TN , t}^{DN , n , k + 1} ) + {K}^{D} [ ( {P}_{DN , n , t}^{TN , k + 1} - {P}_{TN , t}^{DN , n , k + 1} ) - ( {P}_{DN , n , t}^{TN , k} - {P}_{TN , t}^{DN , n , k} ) ] + {K}^{I} {\sum }_{m = {k}^{*}}^{k} ( {P}_{DN , n , t}^{TN , m + 1} - {P}_{TN , t}^{DN , n , m + 1} )$$

In the formula, λ_{DN,n,t}^{TN,k+1} denotes the Lagrange multiplier at the time step t in the k+1^{th} iteration of the transmission grid, λ_{DN,n,t}^{TN,k} denotes the Lagrange multiplier at the time step t in the k^{th} iteration of the power grid, λ_{TN,t}^{DN,n,k+1} denotes the Lagrange multiplier at the time step t in the k+1^{th} iteration of the node of the n^{th} distribution grid, λ_{TN,t}^{DN,n,k} denotes the Lagrange multiplier at the time step t in the k^{th} iteration of the node of the n^{th} distribution grid, ρ_{DN,n}^{TN,k+1} denotes the penalty coefficient of the k+1^{th} iteration of the transmission grid, ρ_{TN,t}^{DN,n,k+1} denotes the penalty coefficient of the k+1 iteration of the distribution grid, K^{D} and K¹ denote an integral and a dual residual adjustment parameter in a classical control theory respectively, P_{DN,n,t}^{TN,k+1} denotes an expected transmission and distribution interaction power strategy matrix at the t step in the k+1^{th} iteration of the transmission grid and P_{TN,t}^{DN,n,k+1} denotes a transmission and distribution interaction power strategy matrix at a time step t in the k+1^{th} iteration of the distribution grid.

Preferably, the original residual and the dual residual of the k^{th} iteration are expressed as follows:

$${p}_{DN , n}^{TN , k , P} = {p}_{TN}^{DN , n , k , P} = {{\sum }_{t = 1}}^{{T}_{step}} {( {P}_{DN , n , t}^{TN , k + 1} - {P}_{TN , t}^{DN , n , k + 1} )}^{2}$$

$${d}_{DN , n}^{TN , k , D} = {d}_{TN}^{DN , n , k , D} = max [ {{\sum }_{t = 1}}^{{T}_{step}} {( {P}_{DN , n , t}^{TN , k + 1} - {P}_{DN , n , t}^{TN , k} )}^{2} , {{\sum }_{t = 1}}^{{T}_{step}} {( {P}_{TN , t}^{DN , n , k + 1} - {P}_{TN , t}^{DN , n , k} )}^{2} ]$$

In the formula, P_{DN,n}^{TN,k,p}=P_{TN}^{DN,n,k,p} denotes the original residual of the k^{th} iteration of the transmission and distribution grid, d_{DN,n}^{TN,k,D}=d_{TN}^{DN,n,k,D} denotes the dual residual of the k^{th} iteration of the transmission and distribution grid, T_{Step} denotes the number of time steps in the restoration process, P_{DN,n,t}^{TN,k+1} denotes the expected transmission and distribution interaction power strategy matrix at the time step t in the k+1^{th} iteration of the transmission grid, and P_{TN,t}^{DN,n,k+1} denotes the transmission and distribution interaction power strategy matrix at the time step t in the k+1^{th} iteration of the distribution grid.

It should be noted that the set threshold of the original residual is 10⁻³˜10⁻⁵.

It should be noted that by adopting the dual updating iteration accelerating strategy, update modes of the penalty coefficient and the Lagrange multiplier can be dynamically adjusted according to a size of the original residual. When the original residual is greater than the set threshold, the penalty coefficient and Lagrange multiplier are updated at the same time to increase the convergence speed of the algorithm and enhance the stability of the algorithm. When the original residual is less than or equal to the set threshold, merely the Lagrange multiplier is updated, and the penalty coefficient is kept unchanged, so as to avoid the shock or instability caused by excessive adjustment of the parameters, and guarantee smooth convergence of the algorithm.

It should be further noted that the strategy of updating the penalty coefficient is combined with the information of the original residual and dual residual, and the penalty coefficient is dynamically adjusted by comparing the original residual with the preset threshold. Thus, the convergence speed and stability of the algorithm are better balanced and the solution accuracy is improved. In addition, the strategy of updating the Lagrange multiplier is also optimized. By introducing the integral and the dual residual adjustment parameter in a classical control theory, the Lagrange multiplier can be adjusted more accurately, and the convergence speed and stability of the algorithm are further improved.

S108: whether the improved alternating direction method of multipliers continues implementing a next round of optimization or terminates iteration and outputs a final coordinated restoration strategy of the transmission and distribution grid is determined according to convergence conditions of the original residual and a dual residual or a number of iterations.

Further, the convergence conditions of the original residual and the dual residual are determined in expressions as follows:

$${p}_{DN , n}^{TN , k , P} \leq {δ}^{P} ⋂ {d}_{DN , n}^{TN , k , D} \leq {δ}^{D} = 1$$

In the formula, P_{DN,n}^{TN,k,p}=P_{TN}^{DN,n,k,p} denotes the original residual of the k^{th} iteration of the transmission and distribution grid, d_{DN,n}^{TN,k,D}=T_{N}^{DN,n,k,D} denotes the dual residual of the k^{th} iteration of the transmission and distribution grid, δ^{P} denotes the original residual convergence threshold and δ^{D} denotes the dual residual convergence threshold.

In a case that the improved alternating direction method of multipliers satisfies the expressions of the convergence conditions of the original residual and the dual residual, or reaches the maximum number of iterations, the final coordinated restoration strategy of the transmission and distribution grid is output.

It should be noted that by introducing a determination mechanism of the convergence of the original residual and the dual residual and limiting the number of iterations, an iteration process of the improved alternating direction method of multipliers can implement fully convergence and terminate within reasonable time, and the final coordinated restoration strategy of the transmission and distribution grid is output accordingly. Waste of computing resources and an decrease of solving efficiency caused by excessive iteration are avoided effectively, and accuracy and reliability of solving results are further guaranteed. In addition, this solution further considers actual situation and demand from the coordinated restoration strategy of the transmission and distribution grid, and feasibility and effectiveness of the strategy in an actual application are guaranteed through reasonable setting of the number of iterations.

The solution described above is an illustrative solution of the method based on improved ADMM for distributed coordinated restoration of a transmission and distribution grid in this example. It should be noted that a technical solution of the system based on improved ADMM for distributed coordinated restoration of a transmission and distribution grid belongs to the same concept as the technical solution of the method based on improved ADMM for distributed coordinated restoration of a transmission and distribution grid. For details not described in detail in the technical solution of the system based on improved ADMM for distributed coordinated restoration of a transmission and distribution grid in this example, reference can be made to the description of the technical solution of the method based on improved ADMM for distributed coordinated restoration of a transmission and distribution grid.

The system based on ADMM for distributed coordinated restoration of a transmission and distribution grid in this example includes:
a data obtainment module configured to obtain relevant data of the transmission and distribution grid, and establish an objective function by maximizing a load restoration yield of the transmission and distribution grid;
an optimization model establishment module configured to establish a coordinated restoration optimization model of the transmission and distribution grid according to the objective function and a constraint condition of the transmission and distribution grid;
a distributed restoration optimization module configured to establish augmented objective functions for a transmission grid and a distribution grid by introducing an augmented Lagrangian function based on the coordinated restoration optimization model of the transmission and distribution grid;
an iteration solving module configured to set a maximum number of iterations, an original residual convergence threshold and a dual residual convergence threshold of the improved alternating direction method of multipliers, and solve the augmented objective functions for the transmission grid and the distribution grid by using the improved alternating direction method of multipliers;
an iteration accelerating strategy module configured to update, by using a dual updating iteration accelerating strategy, a penalty coefficient and a Lagrange multiplier in a case that an original residual is greater than a set threshold, and update, by using the dual updating iteration accelerating strategy, a Lagrange multiplier and keeping a penalty coefficient unchanged in a case that an original residual is less than or equal to a set threshold; and
an optimization result output module configured to determine whether the improved alternating direction method of multipliers continues implementing a next round of optimization or terminates iteration and outputs a final coordinated restoration strategy of the transmission and distribution grid according to convergence conditions of the original residual and a dual residual or a number of iterations.

This example further provides a computation device. The computation device is applied to a case of the distributed coordinated restoration of the transmission and distribution grid based on the ADMM. The computation device includes:
a memory and a processor. The memory is configured to store a computer-executable instruction, and the processor is configured to execute the computer-executable instruction, so as to implement the method based on improved ADMM for distributed coordinated restoration of a transmission and distribution grid according to the example described above.

This example further provides a storage medium. The storage medium stores a computer program. The program implements the method based on improved ADMM for distributed coordinated restoration of a transmission and distribution grid according to the example described above when executed by a processor.

The storage medium according to the example of the present disclosure belongs to the same inventive concept as the method based on improved ADMM for distributed coordinated restoration of a transmission and distribution grid, reference can be made to the example described above for the technical details not described in detail in this example, and this example has the same beneficial effects as the example described above.

It can be clearly understood from the above description of the embodiment by those skilled in the art that the present disclosure may be implemented by means of software and necessary general hardware, and may be certainly implemented by the hardware, between which the former is a preferred embodiment in many cases. Based on such understanding, a technical solution of the present disclosure may be embodied in the form of software products in essence or in part that contributes to the prior art, the computer software products may be stored in the computer-readable storage medium, such as a floppy disk, a read-only memory (ROM), a random access memory (RAM), a FLASH, a hard disk or optical disk, etc. of a computer, and several instructions are included to make a computer device (which may be a personal computer, a server, network equipment, etc.) execute the method of each example of the present disclosure.

### Example 2

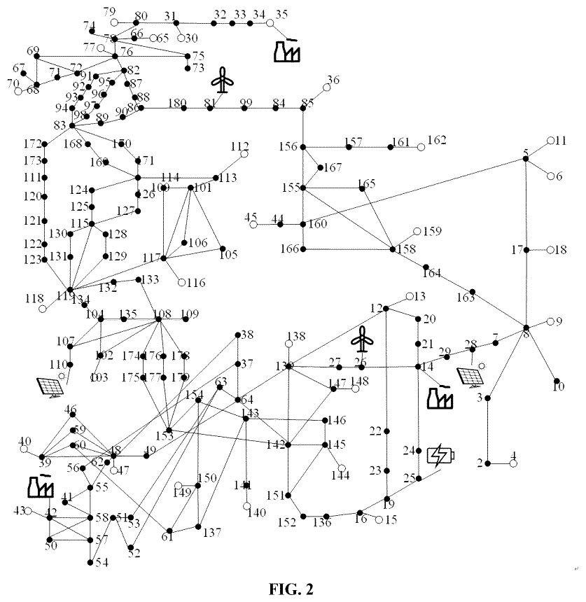

With reference to Table 1 and FIGS. 2-4, a method based on improved ADMM for distributed coordinated restoration of a transmission and distribution grid is provided according to an example of the present disclosure. In order to verify beneficial effects of the method, comparison results of two solutions are provided.

This example makes analysis with an improved 179-node transmission grid shown in FIG. 2 as an example, and each node is connected to an Institute of Electrical and Electronic Engineers(IEEE)-33 bus distribution grid.

Nodes 14, 35 and 42 are connected to a black start unit, nodes 26 and 81 are connected to a wind power station, and nodes 28 and 110 are connected to a photovoltaic power station.

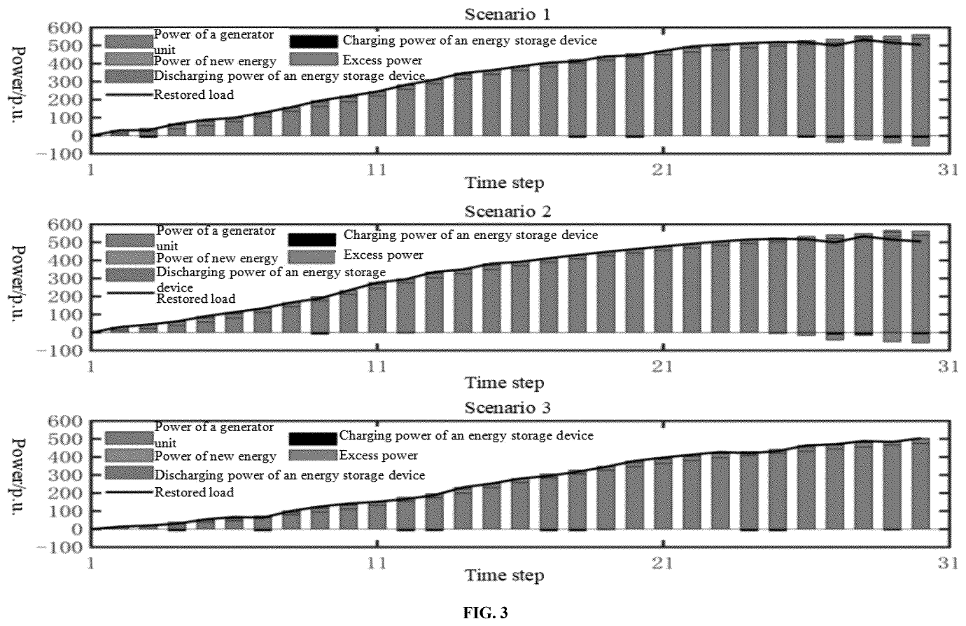

FIG. 3 shows power balance of a transmission system in three different disaster scenarios (in a scenario 1 of outage at 2 o' clock after midnight, merely output of wind power exists; in a scenario 2 of outage at 10 am, output of wind power and photovoltaic power exist; and in a scenario 3 of outage when a typhoon comes, no output of wind power or photovoltaic power exits).

It can be seen from FIG. 3 that in an early stage of restoration (that is, first five time steps), a non-black start unit has not been fully restored, and output of new energy accounts for a large proportion of total output of a system. At the same time, the system also restored part of a load to maintain a frequency of the system stable.

In middle and later periods of the restoration stage (that is, 6-25 time steps), the load also get restored rapidly along with gradual restoration completion of the non-black start unit and gradual reconstruction completion of a grid.

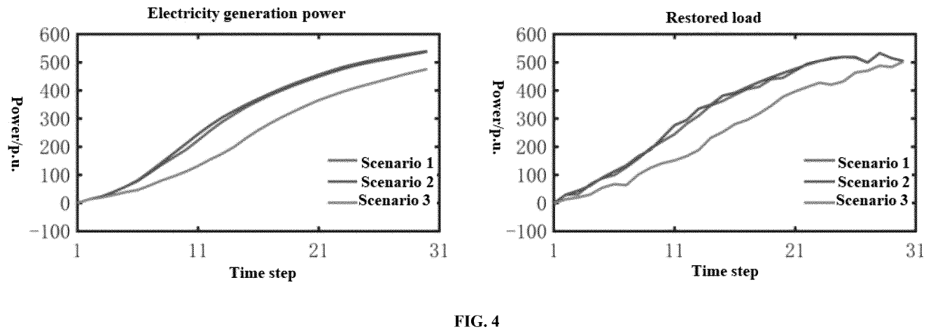

In order to better show influence from different disaster scenarios on an overall restoration process of the transmission system, FIG. 4 shows restoration of electricity generation power and load power of the transmission system in three scenarios.

It can be seen from FIG. 4 that a scenario 2 occurs at 10 am, both wind power and photovoltaic power have output and can be used as black start power sources. Thus, restoration speeds of the electricity generation power and the load power in the scenario 2 are the highest among those of the three scenarios.

The scenario 2 occurs at 2 am, merely output of wind power exists instead of photovoltaic output, a black start speed is slower than a back start speed in the scenario 1, and restoration speeds of the electricity generation power and the load power is slightly slower than those of scenario 1 as a result. In the scenario 3 of the typhoon disaster, no photovoltaic output is caused due to rain, and a wind turbine generator system has no output since a wind speed of the typhoon is higher than switch-off power of the wind turbine generator system. In this case, an energy storage device can be merely used as a black start power supply for black start. Thus, a electricity generation restoration rate in the scenario 3 is 22.35% and 24.11% lower than a electricity generation restoration rate of S1 and a electricity generation restoration rate of S2 respectively, and a load restoration rate is 20.55% and 22.12% lower than a load restoration rate of S1 and a load restoration rate of S2 respectively.

In order to verify effectiveness of the improved alternating direction method of multipliers according to the present disclosure, the solving results of the present disclosure are compared with solving results of a traditional alternating direction method of multipliers, as shown in Table 1.

TABLE 1
Comparison between the improved alternating direction method
of multipliers according to the present disclosure and the
traditional alternating direction method of multipliers

| | Total yield of a | | |
|---|---|---|---|
| | transmission | | |
| | and | | |
| | distribution | Number of | Solving |
| Model | grid | iterations | time/s |
| The improved alternating | 4935.8 | 13 | 15169 |
| direction method of | | | |
| multipliers of the present | | | |
| disclosure | | | |
| The traditional alternating | 4936.7 | 27 | 28343 |
| direction method of | | | |
| multipliers | | | |

It can be seen from Table 1 that a difference percentage between total yields of the transmission and distribution grid solved by the algorithm of the present disclosure and the ordinary alternating direction method of multipliers is within 0.02%, while the number of iterations of the algorithm of the present disclosure is 50% or higher less than the number of iterations of the traditional alternating direction method of multipliers, and the solving time is correspondingly shortened by 13174 s.

It can be known that the improved alternating direction method of multipliers used in the present disclosure can adaptively adjust the penalty factor according to the solving result of each iteration. Thus, the convergence speed of distributed solving is increased, time of distributed solving is shortened, and the restoration model provided by the present disclosure has better practicability.

It should be noted that the examples are merely used to describe the technical solutions of the present disclosure rather than limiting same. Although the present disclosure is described in detail with reference to the preferred examples, those skilled in the art should understand that modifications or equivalent replacements can be made to the technical solutions of the present disclosure without departing from the spirit and scope of the technical solutions of the present disclosure, and should fall within the scope of the claims of the present disclosure.

What is claimed is:

1. A method based on improved alternating direction method of multipliers (ADMM) for distributed coordinated restoration of a transmission and distribution grid, comprising:
obtaining relevant data of the transmission and distribution grid, establishing an objective function by maximizing a load restoration yield of the transmission and distribution grid, and establishing a coordinated restoration optimization model of the transmission and distribution grid according to the objective function and a constraint condition of the transmission and distribution grid;
establishing augmented objective functions for a transmission grid and a distribution grid by introducing an augmented Lagrangian function based on the coordinated restoration optimization model of the transmission and distribution grid;
setting a maximum number of iterations, an original residual convergence threshold and a dual residual convergence threshold of the improved alternating direction method of multipliers, and solving the augmented objective functions for the transmission grid and the distribution grid by using the improved alternating direction method of multipliers;
updating, by using a dual updating iteration accelerating strategy, a penalty coefficient and a Lagrange multiplier in a case that an original residual is greater than a set threshold, and updating, by using the dual updating iteration accelerating strategy, a Lagrange multiplier and keeping a penalty coefficient unchanged in a case that an original residual is less than or equal to a set threshold; and
determining whether the improved alternating direction method of multipliers continues implementing a next round of optimization or terminates iteration and outputs a final coordinated restoration strategy of the transmission and distribution grid according to convergence conditions of the original residual and a dual residual or a number of iterations.

2. The method based on improved ADMM for distributed coordinated restoration of a transmission and distribution grid according to claim 1, wherein the establishing a coordinated restoration optimization model of the transmission and distribution grid according to the objective function and a constraint condition of the transmission and distribution grid comprises:
expressing the objective function as follows:
$$F = max {\sum }_{t = 1}^{T} ( {\sum }_{n = 1}^{{N}_{bus}^{TN}} {b}_{L , n}^{TN} {P}_{L , n , t}^{TN} Δ t + {\sum }_{n = 1}^{{N}_{bus}^{DN}} {b}_{L , n}^{DN} {P}_{L , n , t}^{DN} Δ t )$$
wherein N_{bus}^{TN} and N_{bus}^{DN} denote a number of nodes in the transmission and distribution grid, b_{L,n}^{TN} and b_{L,n}^{DN} denote a load restoration yield per unit of a node n in the transmission grid and a load restoration yield per unit of a node n in the distribution grid respectively, P_{L,n,t}^{TN} and P_{L,n,t}^{DN} denote a load restoration power at a time step t of the node n of the transmission grid and a load restoration power at a time step t of the node n of the distribution grid respectively, Δt denotes a time step interval, and T denotes a number of time steps in a restoration process; and
the constraint condition of the transmission and distribution grid comprises a black start constraint, a load restoration constraint and a power balance constraint of a non-black start unit of the transmission grid, as well as a load restoration constraint and a power balance constraint of the distribution grid.

3. The method based on improved ADMM for distributed coordinated restoration of a transmission and distribution grid according to claim 2, wherein the establishing augmented objective functions for a transmission grid and a distribution grid by introducing an augmented Lagrangian function comprises:
expressing the augmented objective function for the transmission grid as follows:
$${f}^{TN} = max {f}^{TN , B} + {\sum }_{n = 1}^{{N}_{bus , DN}^{TN}} {\sum }_{t = 1}^{{T}_{step}} [ {λ}_{DN , n , t}^{TN} ( {P}_{DN , n , t}^{TN} - {P}_{TN , t}^{DN , n} ) ] + {\sum }_{n = 1}^{{N}_{bus , DN}^{TN}} [ \frac{{ρ}_{DN , n}^{TN}}{2} {\sum }_{i = 1}^{{T}_{step}} {( {P}_{DN , n , t}^{TN} - {P}_{TN , t}^{DN , n} )}^{2} ]$$
wherein f^{TN} denotes the augmented objective function for the transmission grid, λ_{DN,x,t}^{TN} and ρ_{DN,x}^{TN} denotes a Lagrange multiplier and a penalty factor of the transmission grid respectively, P_{L,n,t}^{TN} denotes the load restoration power of the node n at the time step t of the transmission grid, N_{bus,DN}^{TN} denotes a number of coupling nodes of the transmission and distribution grid, T_{Step} denotes the number of time steps in the restoration process, P_{DN,n,t}^{TN} denotes a transmission and distribution grid interaction power expected, by the transmission grid, to be received by an n^{th} distribution grid, P_{TN,t}^{DN,n} denotes a transmission and distribution grid interaction power at which the n^{th} distribution grid expects the transmission grid to transmit, and f^{TN,B} denotes a restoration yield of the transmission grid; and
expressing the augmented objective function for the distribution grid as follows:
$${f}^{DN , n} = max {f}^{DN , n , B} + {\sum }_{t = 1}^{{T}_{step}} [ {λ}_{TN , t}^{DN , n} ( {P}_{DN , n , t}^{TN} - {P}_{TN , t}^{DN , n} ) ] + \frac{{ρ}_{TN}^{DN , n}}{2} {\sum }_{t = 1}^{{T}_{step}} {( {P}_{DN , n , t}^{TN} - {P}_{TN , t}^{DN , n} )}^{2}$$
wherein f^{DN,n} denotes the augmented objective function for the distribution grid, λ_{TN,t}^{DN,n} and ρ_{TN}^{DN,n} denotes a Lagrange multiplier and a penalty factor of the n^{th} distribution grid respectively, P_{L,n,t}^{DN} denotes the load restoration power of the node n at the time step t of the distribution grid, T_{Step} denotes the number of time steps in the restoration process, P_{DN,n,t}^{TN} denotes the transmission and distribution grid interaction power expected, by the transmission grid, to be received by the n^{th} distribution grid, P_{TN,t}^{DN,n} denotes the transmission and distribution grid interaction power at which the n^{th} distribution grid expects the transmission grid to transmit, and f^{DN,n,B} denotes a restoration yield of the distribution grid.

4. The method based on improved ADMM for distributed coordinated restoration of a transmission and distribution grid according to claim 3, wherein the solving the augmented objective functions for the transmission grid and the distribution grid by using the improved alternating direction method of multipliers comprises:
downwards collecting expected transmission and distribution interaction power strategy matrices of distribution grids by the transmission grid, computing the augmented objective function for the transmission grid, and obtaining an expected transmission and distribution interaction power strategy matrix of the transmission grid; and
receiving the expected transmission and distribution interaction power strategy matrix of the transmission grid from the transmission grid by each distribution grid, then computing the augmented objective function for the distribution grid, and obtaining the expected transmission and distribution interaction power strategy matrix of the distribution grid.

5. The method based on improved ADMM for distributed coordinated restoration of a transmission and distribution grid according to claim 4, wherein the updating, by using a dual updating iteration accelerating strategy, a penalty coefficient and a Lagrange multiplier in a case that an original residual is greater than a set threshold comprises:
updating the penalty coefficient as follows:
$${ρ}_{DN , n}^{TN , k + 1} = \{ \begin{matrix}{ρ}_{DN , n}^{TN , k} / [ 1 + lg ( \frac{{d}_{DN , n}^{TN , k , D}}{{p}_{DN , n}^{TN , k , P}} ) ] , & ( \frac{{d}_{DN , n}^{TN , k , D}}{{δ}^{D}} ) \geq \frac{10 {p}_{DN , n}^{TN , k , P}}{{δ}^{P}} \\ {ρ}_{DN , n}^{TN , k} [ 1 + lg ( \frac{{p}_{DN , n}^{TN , k , P}}{{d}_{DN , n}^{TN , k , D}} ) ] , & ( \frac{{p}_{DN , n}^{TN , k , P}}{{δ}^{P}} ) \geq \frac{10 {d}_{DN , n}^{TN , k , D}}{{δ}^{D}} \\ {ρ}_{DN , n}^{TN , k} , & Others\end{matrix}$$
$${ρ}_{TN}^{DN , n , k + 1} = \{ \begin{matrix}{ρ}_{TN}^{DN , n , k} / [ 1 + lg ( \frac{{d}_{TN}^{DN , n , k , D}}{{p}_{TN}^{DN , n , k , P}} ) ] , & ( \frac{{d}_{TN}^{DN , n , k , D}}{{δ}^{D}} ) \geq \frac{10 {p}_{TN}^{DN , n , k , P}}{{δ}^{P}} \\ {ρ}_{TN}^{DN , n , k} [ 1 + lg ( \frac{{p}_{TN}^{DN , n , k , P}}{{d}_{TN}^{DN , n , k , D}} ) ] , & ( \frac{{p}_{TN}^{DN , n , k , P}}{{δ}^{P}} ) \geq \frac{10 {d}_{TN}^{DN , n , k , D}}{{δ}^{D}} \\ {ρ}_{TN}^{DN , n , k} , & Others\end{matrix}$$
wherein P_{DN,n}^{TN,k,p}=P_{TN}^{DN,n,k,p} denotes an original residual of a k^{th} iteration of the transmission and distribution grid, d_{DN,n}^{TN,k,D}=d_{TN}^{DN,n,k,D} denotes a dual residual of the k^{th} iteration of the transmission and distribution grid, ρ_{DN,n}^{TN,k+1} denotes a penalty coefficient of a k+1^{th} iteration of the transmission grid, ρ_{DN,n}^{TN,k} denotes a penalty coefficient of a k^{th} iteration of the transmission grid, ρ_{TN}^{DN,n,k+1} denotes a penalty coefficient of a k+1^{th} iteration of a node of the n^{th} distribution grid, ρ_{TN}^{DN,n,k} denotes a penalty coefficient of a k^{th} iteration of the node of the n^{th} distribution grid, δ^{P} denotes the original residual convergence threshold and δ^{D} denotes the dual residual convergence threshold; and
updating the Lagrange multiplier as follows:
$${λ}_{DN , n , t}^{TN , k + 1} = {λ}_{DN , n , t}^{TN , k} + {ρ}_{DN , n}^{TN , k + 1} ( {P}_{DN , n , t}^{TN , k + 1} - {P}_{TN , t}^{DN , n , k + 1} )$$
$${λ}_{TN , t}^{DN , n , k + 1} = {λ}_{TN , t}^{DN , n , k} + {ρ}_{TN , t}^{DN , n , k + 1} ( {P}_{DN , n , t}^{TN , k + 1} - {P}_{TN , t}^{DN , n , k + 1} )$$
wherein P_{DN,n,t}^{TN,k+1} denotes an expected transmission and distribution interaction power strategy matrix at a time step t in the k+1^{th} iteration of the transmission grid, P_{TN,t}^{DN,n,k+1} denotes a transmission and distribution interaction power strategy matrix at a time step t in a k+1^{th} iteration of the distribution grid, λ_{DN,n,t}^{TN,k+1} denotes a Lagrange multiplier at the time step t in the k+1^{th} iteration of the transmission grid, λ_{DN,n,t}^{TN,k} denotes a Lagrange multiplier at a time step t in the k^{th} iteration of the transmission grid, λ_{TN,t}^{DN,n,k+1} denotes a Lagrange multiplier at a time step t in the k+1^{th} iteration of the node of the n^{th} distribution grid, λ_{TN,t}^{DN,n,k} denotes a Lagrange multiplier at a time step t in the k^{th} iteration of the node of the nth distribution grid, ρ_{DN,n}^{TN,k+1} denotes the penalty coefficient of the k+1^{th} iteration of the transmission grid and ρ_{TN,t}^{DN,n,k+1} denotes a penalty coefficient of the k+1^{th} iteration of the distribution grid.

6. The method based on improved ADMM for distributed coordinated restoration of a transmission and distribution grid according to claim 5, wherein the updating, by using the dual updating iteration accelerating strategy, a Lagrange multiplier and keeping a penalty coefficient unchanged in a case that an original residual is less than or equal to a set threshold comprises:
updating the Lagrange multiplier as follows:
$${λ}_{DN , n , t}^{TN , k + 1} = {λ}_{DN , n , t}^{TN , k} + {ρ}_{DN , n}^{TN , k + 1} ( {P}_{DN , n , t}^{TN , k + 1} - {P}_{TN , t}^{DN , n , k + 1} ) + {K}^{D} [ ( {P}_{DN , n , t}^{TN , k + 1} - {P}_{TN , t}^{DN , n , k + 1} ) - ( {P}_{DN , n , t}^{TN , k} - {P}_{TN , t}^{DN , n , k} ) ] + {K}^{I} {\sum }_{m = {k}^{*}}^{k} ( {P}_{DN , n , t}^{TN , m + 1} - {P}_{TN , t}^{DN , n , m + 1} )$$
$${λ}_{TN , t}^{DN , n , k + 1} = {λ}_{TN , t}^{DN , n , k} + {ρ}_{TN , t}^{DN , n , k + 1} ( {P}_{DN , n , t}^{TN , k + 1} - {P}_{TN , t}^{DN , n , k + 1} ) + {K}^{D} [ ( {P}_{DN , n , t}^{TN , k + 1} - {P}_{TN , t}^{DN , n , k + 1} ) - ( {P}_{DN , n , t}^{TN , k} - {P}_{TN , t}^{DN , n , k} ) ] + {K}^{I} {\sum }_{m = {k}^{*}}^{k} ( {P}_{DN , n , t}^{TN , m + 1} - {P}_{TN , t}^{DN , n , m + 1} )$$
wherein λ_{DN,n,t}^{TN,k+1} denotes the Lagrange multiplier at the time step t in the k+1^{th} iteration of the transmission grid, λ_{DN,n,t}^{TN,k} denotes the Lagrange multiplier at the time step t in the k^{th} iteration of the power grid, λ_{TN,t}^{DN,n,k+1} denotes the Lagrange multiplier at the time step t in the k+1^{th} iteration of the node of the n^{th} distribution grid, λ_{TN,t}^{DN,n,k} denotes the Lagrange multiplier at the time step t in the k^{th} iteration of the node of the n^{th} distribution grid, ρ_{DN,n}^{TN,k+1} denotes the penalty coefficient of the k+1^{th} iteration of the transmission grid, ρ_{TN,t}^{DN,n,k+1} denotes the penalty coefficient of the k+1 iteration of the distribution grid, K^{D} and K¹ denote an integral and a dual residual adjustment parameter in a classical control theory respectively, P_{DN,n,t}^{TN,k+1} denotes an expected transmission and distribution interaction power strategy matrix at the t step in the k+1^{th} iteration of the transmission grid and P_{TN,t}^{DN,n,k+1} denotes a transmission and distribution interaction power strategy matrix at a time step t in the k+1^{th} iteration of the distribution grid.

7. The method based on improved ADMM for distributed coordinated restoration of a transmission and distribution grid according to claim 6, wherein the determining whether the improved alternating direction method of multipliers continues implementing a next round of optimization or terminates iteration and outputs a final coordinated restoration strategy of the transmission and distribution grid according to convergence conditions of the original residual and a dual residual or a number of iterations comprises:
determining the convergence conditions of the original residual and the dual residual in expressions as follows:
$${p}_{DN , n}^{TN , k , P} \leq {δ}^{P} ⋂ {d}_{DN , n}^{TN , k , D} \leq {δ}^{D} = 1$$
wherein P_{DN,n}^{TN,k,p}=P_{TN}^{DN,n,k,p} denotes the original residual of the k^{th} iteration of the transmission and distribution grid, d_{DN,n}^{TN,k,D}=d_{TN}^{DN,n,k,D} denotes the dual residual of the k^{th} iteration of the transmission and distribution grid, δ^{P} denotes the original residual convergence threshold and δ^{D} denotes the dual residual convergence threshold; and
in a case that the improved alternating direction method of multipliers satisfies the expressions of the convergence conditions of the original residual and the dual residual, or reaches the maximum number of iterations, outputting the final coordinated restoration strategy of the transmission and distribution grid.

8. A system based on ADMM for distributed coordinated restoration of a transmission and distribution grid, comprising:
a data obtainment module configured to obtain relevant data of the transmission and distribution grid, and establish an objective function by maximizing a load restoration yield of the transmission and distribution grid;
an optimization model establishment module configured to establish a coordinated restoration optimization model of the transmission and distribution grid according to the objective function and a constraint condition of the transmission and distribution grid;
a distributed restoration optimization module configured to establish augmented objective functions for a transmission grid and a distribution grid by introducing an augmented Lagrangian function based on the coordinated restoration optimization model of the transmission and distribution grid;
an iteration solving module configured to set a maximum number of iterations, an original residual convergence threshold and a dual residual convergence threshold of the improved alternating direction method of multipliers, and solve the augmented objective functions for the transmission grid and the distribution grid by using the improved alternating direction method of multipliers;
an iteration accelerating strategy module configured to update, by using a dual updating iteration accelerating strategy, a penalty coefficient and a Lagrange multiplier in a case that an original residual is greater than a set threshold, and update, by using the dual updating iteration accelerating strategy, a Lagrange multiplier and keeping a penalty coefficient unchanged in a case that an original residual is less than or equal to a set threshold; and
an optimization result output module configured to determine whether the improved alternating direction method of multipliers continues implementing a next round of optimization or terminates iteration and outputs a final coordinated restoration strategy of the transmission and distribution grid according to convergence conditions of the original residual and a dual residual or a number of iterations.

9. An electronic device, comprising:
a memory and a processor; wherein
the memory is configured to store a computer-executable instruction, the processor is configured to execute the computer-executable instruction, and the computer-executable instruction implements steps of the method based on improved ADMM for distributed coordinated restoration of a transmission and distribution grid according to claim 1 when executed by the processor.

10. A computer-readable storage medium, storing a computer-executable instruction, wherein the computer-executable instruction implements steps of the method based on improved ADMM for distributed coordinated restoration of a transmission and distribution grid according to claim 1 when executed by a processor.
